(19) United States
(12) Patent Application Publication
(10) Pub. No.: US 2023/0234157 A1
(43) Pub. Date: Jul. 27, 2023

(54) ARC BRAZING METHOD OF BONDING DIFFERENT MATERIALS AND A PART FOR A VEHICLE

(71) Applicants: HYUNDAI MOTOR COMPANY, Seoul (KR); KIA CORPORATION, Seoul (KR); HWASHIN CO., LTD., Yeongcheon-si (KR); SHINHAN TECHNOLOGY CO., LTD, Seoul (KR)

(72) Inventors: Mun-Gu Kang, Suwon-si (KR); Youn-Il Jung, Seoul (KR); Young-Rae Jo, Seoul (KR); Jae-Young Han, Seoul (KR); Byeong-Nyeon Kim, Daegu (KR)

(73) Assignees: HYUNDAI MOTOR COMPANY, Seoul (KR); KIA CORPORATION, Seoul (KR); HWASHIN CO., LTD., Yeongcheon-si (KR); SHINHAN TECHNOLOGY CO., LTD, Seoul (KR)

(21) Appl. No.: 17/715,828

(22) Filed: Apr. 7, 2022

(30) Foreign Application Priority Data
Jan. 27, 2022 (KR) 10-2022-0012544

(51) Int. Cl. B23K 9/173; B23K 1/00; B23K 1/19; B23K 9/00; B23K 9/23; B23K 35/28

(52) U.S. Cl. CPC B23K 9/173; B23K 1/0008; B23K 1/19; B23K 9/0026; B23K 9/23; B23K 35/282; B23K 2101/006

(57) ABSTRACT

An arc brazing method of bonding different materials includes disposing an aluminum alloy to be bonded on a steel base material and arc brazing a welded portion between the steel base material and the aluminum alloy using a wire. The wire is an alloy containing Zn. It is possible to compensate for brittleness due to the bonding of different materials and to improve wettability.

### CROSS-REFERENCE TO RELATED APPLICATION

This application claims priority to Korean Patent Application No. 10-2022-0012544, filed on Jan. 27, 2022, which is incorporated herein by reference in its entirety.

### BACKGROUND

### Field of the Disclosure

The present disclosure relates to an arc brazing method of bonding different materials and a part for a vehicle bonded by the method.

### Description of Related Art

For example, as a method for bonding steel and aluminum shapes, physical bonding methods such as an adhesive and mechanical fastening have been widely used. More recently, fusion bonding through arc or laser welding has begun to be applied. Since the applied heat source (arc or laser) is high energy, the bonding between materials is achieved through fusion bonding in aluminum and diffusion bonding in steel. For the arc or laser bonding, the bonding is performed through an applied wire other than autogenous welding, and usually, a wire coated with aluminum or zinc alloy and flux is also used.

The steel and aluminum alloy is bonded through arc welding (performing tungsten inert gas (TIG) welding followed by metal inert gas (MIG) welding). For bonding the steel, which is the base material, and the aluminum, the wire material component and steel, and the wire material component and aluminum should be smoothly reacted by using the applied wire (wire, filler metal, or brazing filler metal). Therefore, an aluminum wire is mainly used as well.

However, when the aluminum wire is used, an Al—Fe intermetallic compound is generated through the reaction between the aluminum and the iron component of the steel. If the area of the generated intermetallic compound is 10 μm or more, fracture easily occurs due to brittle intermetallic compound properties. Therefore, many studies have been conducted to reduce the distribution size of these intermetallic compounds.

The contents described in the Description of Related Art section are to help in understanding the background of the present disclosure. Thus, this section may include what is not previously known to those having ordinary skill in the art to which the present disclosure pertains.

### SUMMARY

The present disclosure has been made in efforts to solve the above problems associated with the related art. An object of the present disclosure is to provide an arc brazing method of bonding different materials, whereby the method compensates for brittleness and improves wettability due to the bonding of different materials. Another object of the present disclosure is to provide a part for a vehicle formed by the method.

An arc brazing method of bonding different materials according to one aspect of the present disclosure includes disposing an aluminum alloy to be bonded on a steel base material and arc brazing a welded portion between the steel base material and the aluminum alloy using a wire, in which the wire is an alloy containing Zn.

In addition, the steel base material is a steel sheet having a steel surface plated with a plating layer containing Zn.

In addition, the plating layer contains 90.0 to 99.8 wt % of Zn, 0.1 to 5.0 wt % of Mg, and 0.1 to 5.0 wt % of Al.

Furthermore, the thickness of the plating layer is 1 to 12 μm, and a coating amount is 20 to 200 g/m².

Still further, the wire contains 95.5 to 96.5 wt % of Zn, 3.5 to 4.5 wt % of Al, and 0.03 wt % or less of Si.

In addition, the arc brazing includes preheating the base material by tungsten inert gas (TIG) welding and generating a molten pool in the welded portion by melting the wire by metal inert gas (MIG) welding.

In addition, a wetting angle of the molten pool is 30 degrees or less.

Furthermore, intermetallic compounds containing Zn—Fe and Al—Fe—Zn are generated in a 100 μm±10 μm area from a bonded surface between the steel base material and the wire.

The present disclosure includes a part for a vehicle bonded by the arc brazing method of bonding different materials.

According to the disclosed arc brazing method of bonding different materials, it is possible to improve the wettability of the steel surface using Zn—Mg—Al surface treatment steel (ZM steel), which is the base material, and the Zn wire.

Therefore, the lapping shape between the steel and aluminum materials is bonded through the arc welding and the excellent interface state is achieved through the micro-structure.

The ZM steel indicates the value of 50% or more of the fracture strength of the aluminum base material through the aluminum material and the Zn wire.

### BRIEF DESCRIPTION OF THE DRAWINGS

FIG. 1 shows Al—Fe compound cracks when an aluminum wire is applied for steel-aluminum bonding.

FIG. 2 shows an example of an arc brazing method of bonding different materials according to the present disclosure.

FIG. 3 shows a wetting angle of a molten pool.

FIG. 4 shows a wetting angle bonded by the bonding method according to the present disclosure.

FIG. 5 is a micro-structure observation result for a portion within the box shown in FIG. 4.

FIG. 6 and FIG. 7 are scanning electron microscopy (SEM) energy dispersive or x-ray spectroscopy (EDS) analysis results for the portion depicted in FIG. 5.

FIG. 8 shows tensile fracture strength test results during arc welding of a lapping shape of a Zn—Mg—Al surface treatment steel (ZM steel)-aluminum alloy.

### DESCRIPTION OF SPECIFIC EMBODIMENTS

To fully understand the present disclosure, the operational advantages of the present disclosure, and the objects achieved by practicing the present disclosure, reference should be made to the accompanying drawings showing an embodiment of the present disclosure and the contents described in the accompanying drawings.

In describing the embodiments of the present disclosure, a description of well-known technologies or repetitive descriptions that may obscure the gist of the present disclosure have been reduced or omitted.

The present disclosure relates to a method for bonding different materials of a base material and a welded metal by arc brazing. The present disclosure also relates to a part for a vehicle manufactured by the bonding method. In the method and the vehicle part, the base material can be steel and the welded metal can be aluminum.

The steel and aluminum alloy are bonded through arc welding (i.e., performing tungsten inert gas (TIG) welding followed by metal inert gas (MIG) welding). Brazing is performed by using wire (wire, filler metal, or brazing filler metal) for bonding the steel, which is the base material, and the aluminum.

However, when an aluminum wire is used, an Al—Fe intermetallic compound is generated through the reaction between the aluminum and the iron component of the steel as shown in FIG. 1. If the area of the generated intermetallic compound is 10 μm or more, fracture easily occurs due to brittle intermetallic compound properties.

When using an Al or Zn wire, wettability to the steel is important, because a diffusion bonding is easily performed only when the wettability between the wire is sufficient and the steel surface as the wire is melted by an arc heat source.

First, when using a ZnAl wire in an A6061 plate, as a result of performing the welding at currents of 120 A and 100 A, wettability was sufficient because widths of beads were 14 mm and 10 mm, respectively. However, as a result of performing the welding at currents of 80 A and 30 A, the wettability was undesirable because the widths of the beads were 5 mm and 3 mm, respectively.

In addition, when an A4043 wire was used for A6061 plate, as a result of performing the welding at currents of 180 A and 150 A, the bead width was 11 mm and 7 mm, respectively, and wettability was sufficient. However, as a result of performing the welding at current of 1000 A, 60 A, 30 A, the wettability was undesirable because the widths of all beads were 4 mm.

However, for the steel material, the wettability evaluation result with the wire material varies depending upon the steel surface treatment. For example, for a galvannealed steel (Zn heat treatment plated steel sheet), since the steel surface treatment has undesirable wettability, the steel and the aluminum are not bonded. It is determined that this is caused by the non-uniformity of the surface roughness because the surface component of the steel material comprises or consists of an intermetallic compound (Al—Zn—Fe) with a high melting point according to the heat treatment and does not react with the wire.

To confirm this, as a result of evaluating the wettability of galvannealed steel (GA) alloy (galvannealed steel) and Zn—Mg—Al surface treatment steel sheet (ZM steel) alloy using a Zn wire, it was seen that there were many differences in the degree of spread of the welded portion even under the same welding conditions.

In other words, for the GA alloy, as a result of performing the welding at currents of 60 A, 30 A, and 10 A, the wettability was undesirable because the widths of the beads were 5 mm, 4 mm, and 3 mm, respectively. However, for the ZM alloy, as a result of performing the welding at currents of 60 A, 30 A, and 10 A, the wettability was useful because the widths of the beads were 16 mm, 12 mm, and 10 mm, respectively.

Therefore, the present disclosure presents a method for bonding a ZM steel-Al alloy with excellent bonding force and mechanical properties. The method applies a Zn—Mg plated steel sheet (the same process as those of the ZM alloy and the GA alloy, and an alloy having the steel surface plated with Zn—Mg after being immersed in the Zn—Mg molten metal), which is the high corrosion resistance alloy, other than the zinc heat treatment plated steel sheet (GA alloy; alloyed molten zinc plated steel sheet, alloy having the steel surface plated with a zinc compound by immersing the steel into the molten zinc and then heat-treating it), as the steel surface treatment alloy in the conventional arc brazing treatment.

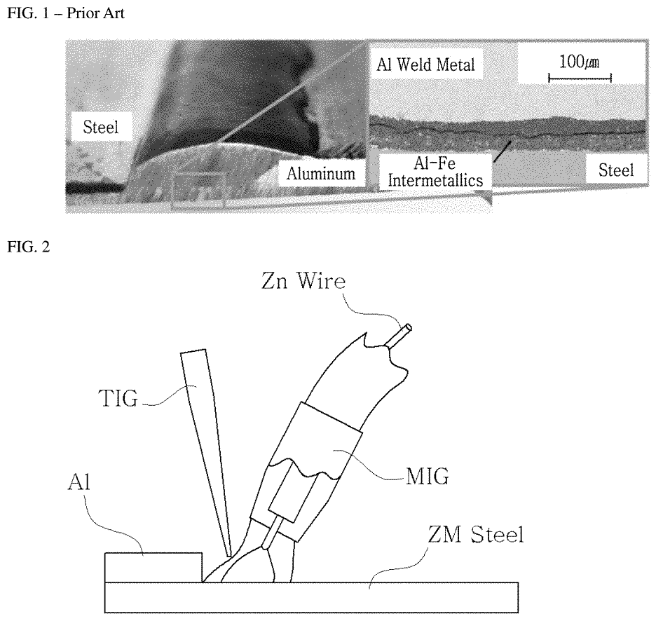

FIG. 2 shows an example of an arc brazing method of bonding different materials according to the present disclosure.

Hereinafter, an arc brazing method of bonding different materials and a part for a vehicle according to an embodiment of the present disclosure should be described with reference to FIG. 2.

An arc brazing method of bonding different materials according to the present disclosure disposes the molten metal in the base material and bonds a welded portion between the base material and the molten metal by arc brazing. The arc brazing bonds the base material and the molten metal by preheating the base material by TIG welding and sequentially performing MIG welding to melt the wire and generate the molten pool.

The base material is the ZM steel as described above. The Zn—Mg plated steel sheet in which the steel surface is immersed in the molten Zn—Mg and surface-plated is suitable.

A surface layer formed by plating is composed of 90.0 to 99.8 wt % of Zn, 0.1 to 5.0 wt % of Mg, and 0.1 to 5.0 wt % of Al. The thickness thereof can be 1 to 12 mm, the thickness of the base material is 1.2 mm, and the coating amount of the plating layer can be 20 to 200 g/m².

In one example, the welded metal to be bonded is aluminum and the wire applied by an applied MIG welding rod is a Zn—Al alloy (Zn wire).

The Zn wire can be composed of 95.5 to 96.5 wt % of Zn, 3.5 to 4.5 wt % of Al, and 0.03 wt % or less of Si.

As described above, by applying the wire material as Zn, the Al—Fe reaction is fundamentally suppressed and the reaction with Fe—Zn occurs. Therefore, an intermetallic compound is generated but is dispersed in the primary Zn and has no brittle characteristics due to the primary Zn with flexibility and no restriction to the thickness of the intermetallic compound.

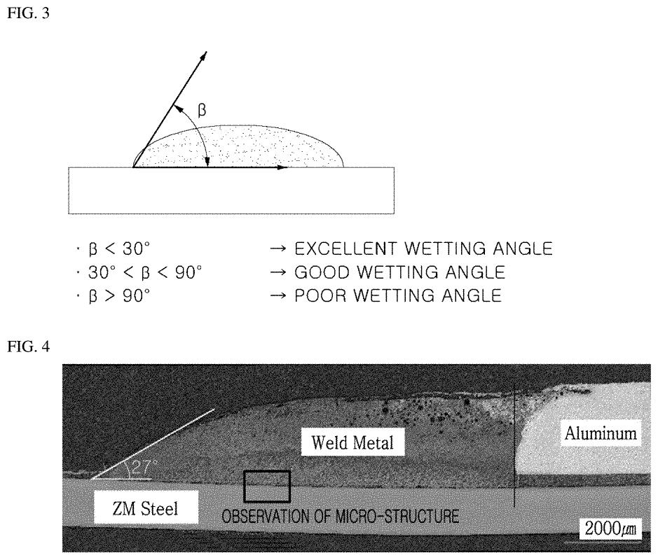

As shown in FIG. 3, the wetting angle (β) is an angle between the surface tension between the solid and the liquid and the surface tension between the liquid and the gas. When this value is low, wettability is useful. Therefore, the molten Zn wire spreads well on the steel surface and the reactivity with Zn between Zn and the steel surface is improved.

As a result of applying the ZM steel, the arc (TIG+MIG), and the Zn wire and applying two types of GA alloys under the same conditions by the aforementioned bonding method according to the present disclosure, it was seen that the GA alloy had the wetting angles of 171 and 178 degrees, respectively and the ZM alloy had wettability improved over the GA alloy because the ZM alloy had a wetting angle of 55 degrees.

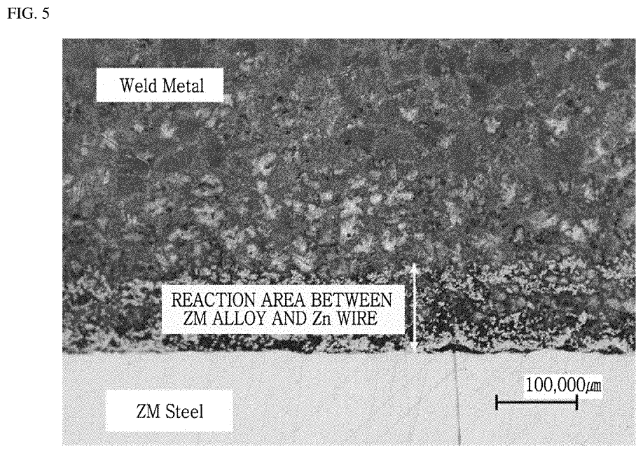

Next, FIG. 4 shows a micro-structure observation result of the welded part bonded by the bonding method according to the present disclosure.

The observation result is the result of the lap welding that bonds an aluminum (A6061-T6, 2.0 t) to a ZM alloy 1.2 t as a base material by the arc (TIG+MIG) welding and uses the Zn wire.

The TIG between welding of an experimental example, a welding speed of a MIG welding machine, a wire supply speed, a control of an arc length, and a TIG current are summarized in the following table. Looking at the welded bonded cross section, it can be seen that the wetting angle is 27 degrees.

TABLE 1

| Welding conditions | Value |
|---|---|
| Welding speed (cm/min) | 35 |
| Wire supply speed (m/min) | 6.5 |
| Arc length correction | −15 |
| CTWD (mm) | 15 |
| TIG Current (mA) | 20 |
| TIG CTWD (mm) | 8 |
| Wire | Φ1.2 |

Observation was performed by using optical and scanning electron microscopes to evaluate the bondability between the ZM steel surface and the Zn wire.

As a result of observing the micro-structure between the ZM steel surface and the Zn wire, it can be confirmed that the reaction between the surface Zn, Mg, and Al of the ZM alloy and Zn and Al of the Zn wire occurred as shown in FIG. 5, and that the reaction area between the ZM alloy and the Zn wire was generated at 100 μm±10 μm. It can be seen that this area does not comprise or consist of only the intermetallic compound but is distributed between the primary Zn.

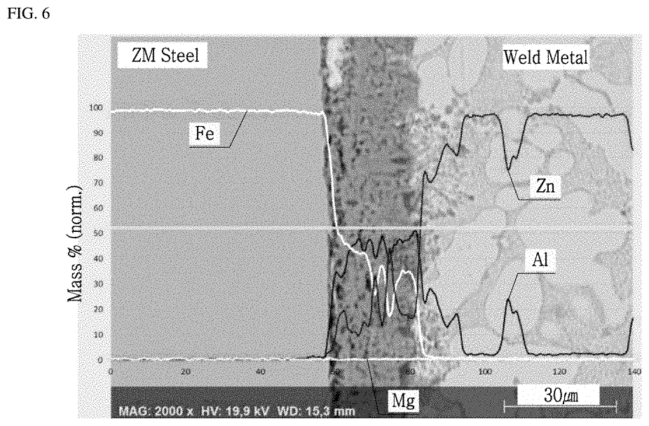

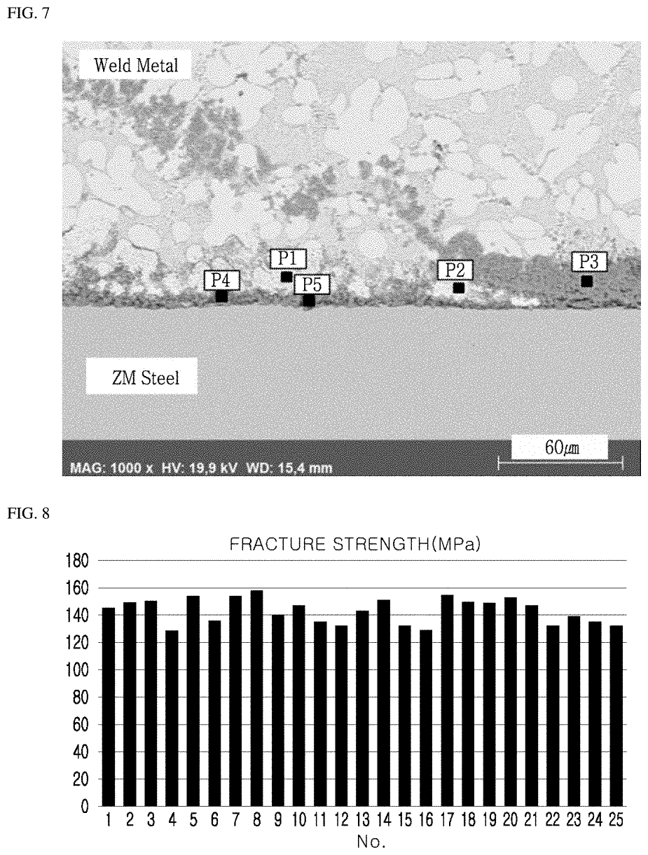

In addition, as shown in FIG. 6, as a result of measuring the scanning electron microscope (SEM) energy dispersive or x-ray spectroscopy (EDS) line profile, it can be seen that the ZM steel surface comprises or consists of Zn—Mg—Al elements and that some Zn—Fe and the Al—Fe—Zn intermetallic compounds are generated and distributed between the primary Zn regions. FIG. 7 and Table 2 show the EDS analysis results (wt. %) for each position.

TABLE 2

| | wt. % | | | | | |
|---|---|---|---|---|---|---|
| No. 1 | Mg | Al | Si | Fe | Zn | Sum |
| P1 | 0.54 | 3.00 | 0.18 | 1.30 | 94.98 | 100 |
| P2 | 0.42 | 3.44 | 0.18 | 2.34 | 93.56 | 100 |
| P3 | 0.41 | 48.37 | 0.23 | 34.75 | 16.11 | 100 |
| P4 | 0.47 | 49.13 | 0.13 | 24.73 | 25.52 | 100 |
| P5 | 0.46 | 49.92 | 0.12 | 37.27 | 12.27 | 100 |

Next, as a result of observing the micro-structure, the tensile evaluation was performed by welding the steel-aluminum material with the lapping shape under the welding conditions of Table 1.

The observation result is the result of the lap welding that bonds an aluminum (A6061-T6, 2.0 t) to a ZM alloy 1.2 t as a base material by the arc (TIG+MIG) welding and uses the Zn wire.

The results of the tensile fracture strength in the lapping shape between the steel material of the ZM alloy and the A6061 (T6) aluminum material are shown in FIG. 8. The result shows the fracture strength of about 50% compared to the strength of the base material due to a difference in the thicknesses of the materials and the mechanical difference according to the shape of the welded portion in the uniaxial tensile test according to the lapping shape. The fracture strength of the base material of the ZM alloy (1.2 t) is 282 MPa and the fracture strength of the aluminum alloy of the aluminum material (A6061-T6) is 297 MPa.

This shows a value equal to or higher than about 45%, which is the uniaxial tensile fracture strength obtained by the arc welding of the lapping shape of the same material of the same thickness (A6061-T6, 3.0 t).

The present disclosure has been described above with reference to the drawings. However, it should be apparent to those having ordinary skill in the art that the present disclosure is not limited to the embodiments described and can be variously modified and changed without departing from the spirit and scope of the present disclosure. Therefore, these modifications and changes should be included in the claims of the present disclosure, and the scope of the present disclosure should be interpreted based on the appended claims.

What is claimed is:

1. An arc brazing method of bonding different materials, the method comprising:
disposing an aluminum alloy to be bonded on a steel base material; and
arc brazing a welded portion between the steel base material and the aluminum alloy using a wire,
wherein the wire is an alloy comprising Zinc (Zn).

2. The method of claim 1,
wherein the steel base material is a steel sheet having a steel surface plated with a plating layer comprising Zn.

3. The method of claim 2,
wherein the plating layer comprises: 90.0 to 99.8 wt % of Zn, 0.1 to 5.0 wt % of Magnesium (Mg), and 0.1 to 5.0 wt % of Aluminum (Al).

4. The method of claim 3,
wherein the thickness of the plating layer is 1 to 12 μm, and a coating amount is 20 to 200 g/m².

5. The method of claim 3,
wherein the wire comprises: 95.5 to 96.5 wt % of Zn, 3.5 to 4.5 wt % of Al, and 0.03 wt % or less of Silicon (Si).

6. The method of claim 5,
wherein the arc brazing comprises:
preheating the base material by tungsten inert gas (TIG) welding; and
generating a molten pool in the welded portion by melting the wire by metal inert gas (MIG) welding.

7. The method of claim 6,
wherein a wetting angle of the molten pool is 30 degrees or less.

8. The method of claim 5,
wherein intermetallic compounds comprising: Zn—Fe (zinc-iron) and Al—Fe—Zn (aluminum-iron-zinc) are generated in a 100 μm±10 μm area from a bonded surface between the steel base material and the wire.

9. A part for a vehicle bonded by the arc brazing method of bonding different materials of claim 1.
